(19) United States
(12) Patent Application Publication
(10) Pub. No.: US 2012/0238925 A1
(43) Pub. Date: Sep. 20, 2012

(54) Interchangeable pressure therapy tool

(76) Inventor: Christopher Thomason Winkley, Austin, TX (US)

(21) Appl. No.: 13/065,184

(22) Filed: Mar. 17, 2011

(51) Int. Cl. A61H 15/00

(52) U.S. Cl. 601/118

(57) ABSTRACT

The present invention is a hand-held interchangeable pressure therapy tool containing a center rod (7), three polyurethane wheels (2, 3, 4), a threaded polyurethane removable knob (1), two neoprene foam cylindrical pads (5, 6), a solid rubber ball housing an internal threaded cap (10) and two neoprene handle sleeves (8, 9).The components of the device can be interchanged and ordered differently on the center rod (7) which gives the invention multiple therapeutic massage tools which can be used in numerous ways to provide musculoskeletal relief. It can be adjusted for anyone and be used effectively anywhere. Therapists and individual users of the invention have many tools included in the device making the device effective for any situation, safe and easy to use.

### CROSS REFERENCE TO RELATED PATENT APPLICATIONS

### U.S. Patent Documents

U.S. Pat. D. 376, 853 by Chen-Chia Hsia, received on Dec. 24, 1996, describes a hand held massager with a ribbed massager head and long handle which is hit against the user to provide percussion massage.

U.S. Pat. D. 385,965 by Margaret J. Wilson, received on Nov. 4, 1997, describes a circular, ball shaped extension at the end of a longer cylindrical base. This ball at the end of the invention is used to roll on the users' foot or other body part.

U.S. Pat. D. 447,810 S by Shari Ann Hannah, received on Sep. 11, 2001, describes an extended extension piece attached centrally to a small hand sized rod where grooves sit to enable a user a place to hold the tool.

U.S. Pat. D. 270,274 by Kirby A. Hamilton, received on Aug. 23, 1983, describes a hand held massager with two balls at the end of the invention to be rolled against the body.

U.S. Pat. D. 269,375 by Isamu Masuda, received on Jun. 14, 1983, describes a hand held rolling massager with an indented center piece, where two higher ridges elevate from the center point to make contact on both sides of the persons spine. The invention also describes two handles on opposite sides of the invention to be easily held by the user and provide a powerful pressure release tool.

### BACKGROUND OF THE INVENTION

The present invention relates to handheld massagers used for therapeutic pressure and massage, Massage and Vibrators classification section (D24/215). The device is used to stimulate a form of effleurage, percussion or sports massage, pressure point therapy, spinal mobilization or spinal decompression on the user themselves or on another person. The massager is interchangeable by detaching the ends of the device which allows the user a variety of forms of massage suitable for different sizes of people and preferences of contact pressure intensity. This device allows the user to massage his or her entire body or another person by changing the order of the components of the device to address the needs of each person. There are many handheld massage tools but very few have interchangeable components which allow for multiple sources of massage to be used in a variety of ways on different sizes of people. Personal relief of pain and musculoskeletal problems are a major concern and expense for most people. This device enables the user to have a unique personal source of massage and pressure relief to his or her body which can provide excellent therapeutic benefits for themselves or another person.

### BRIEF SUMMARY OF THE INVENTION

The invented device is a handheld massage tool that contains interchangeable components used to provide a variety of forms of massage. The design of the massager allows the user to interchange the components to enable the tool to be used in several ways on different sizes of people and provides different forms of pressure therapy and massage. This personal massager has several special features which enhances the user's ability to relieve problematic musculoskeletal pain. The device contains three ribbed massage wheels that can be used for massage, pressure point release and spinal mobilization. The wheels can be placed together at the end of the device, and hit against the user, which increases the weight behind the percussive massage therefore results in a deeper percussive massage. When separated by one of the foam spacers, the wheels also can be used as a percussive massage, but will have less pressure in comparison than the two or three wheels together. This enables people to alter the intensity of the device as a percussive massager which makes to device useable for anyone.

The wheels can also be spaced out from each other by two removable, different sized pieces of foam which can be independently placed between the wheels. The foam pieces are sized to fit over the spinous process of the vertebrae in a larger or smaller person depending on which piece is between the wheels. This allows the wheels to also make contact with the muscle groups running along each side of the spine and on the transverse processes of the spine. The user can then move against a wall, table, floor or mat with the device behind them and create an effective therapeutic pressure to induce muscular tension release and spinal mobilization.

The invented device contains two other tools for massage and musculoskeletal tension release. Each end of the device has either a strong pressure point knob or a solid rubber ball. The knob and ball can be used for pressure point therapy when pressed into the body and the ball can be detached to be use separately away from the invention. After the ball is detached and rolled on by the user against a hard surface, it becomes a multidirectional pressure point release tool which can achieve neuromuscular and joint pain relief. The two foam pieces can also be placed together on the center rod to form a longer chain of foam that can be used to support the users' neck and relax or reduce cervical tension. All of these tools combined into one interchangeable pressure therapy device give the user the ability to relieve musculoskeletal pain on themselves and on another person in several effective ways. Most personal massagers do not have the versatility to interchange for each user and also be used in a variety of ways to improve numerous troublesome physical problems. This device not only contains unique percussive and pressure point therapy tools but also a special spinal mobilization tool to be used by almost anyone and achieve effective relief of pain and neuromuscular tension.

### BRIEF DESCRIPTION OF THE DRAWING FIGS.

The features and components of the invention will become apparent to the reader through a consideration of the Detailed Description of the Invention in conjunction with the Drawing Figures, in which:

FIG. 1. is an anterior view of the device with all three wheels together at the top of the device;

FIG. 2. is an anterior view of the device displaying the large foam pad between two of the wheels, with the other wheel being placed on the opposite end of the device;

FIG. 3. is an anterior view of the device displaying the small foam pad between two of the wheels, with the other wheel being placed on the opposite end of the device;

FIG. 4. is a view of the solid rubber ball and it connecting to the center rod of FIG. 1;

FIG. 5. is an anterior view of the device displaying both foam pads together between two of the wheels, with the other wheel being placed on the opposite end of the device of FIGS. 1; and

FIG. 6. is a view of the pressure point knob connecting into a plastic extension piece of FIG. 1.

### DETAILED DESCRIPTION OF THE DEVICE

As used herein, examples and illustrations are exemplary in nature and not limiting. Like reference numerals between the various Figures indicate like elements.

### Explanation of the Device

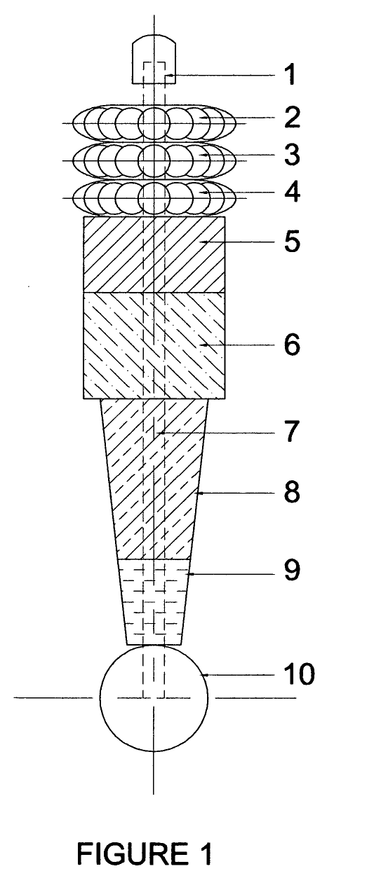

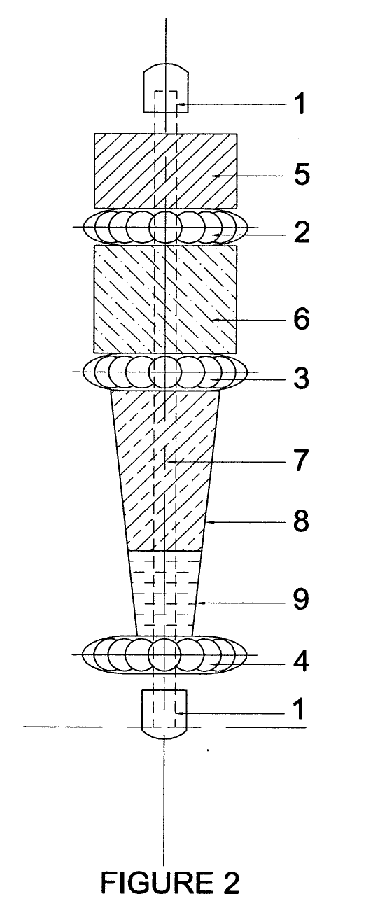

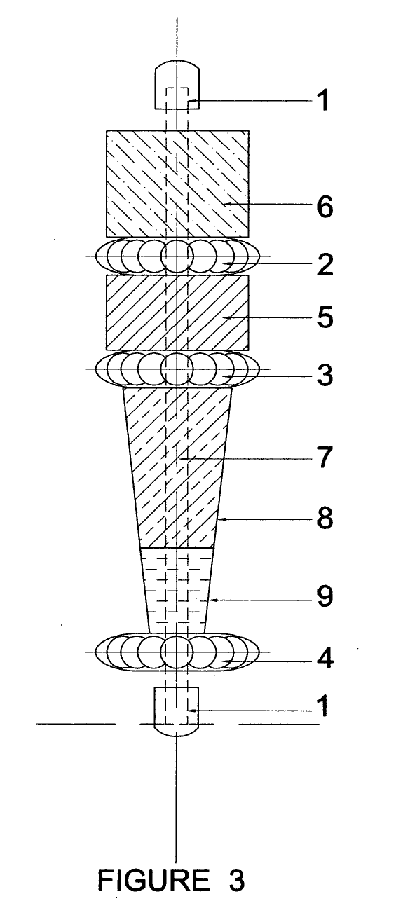

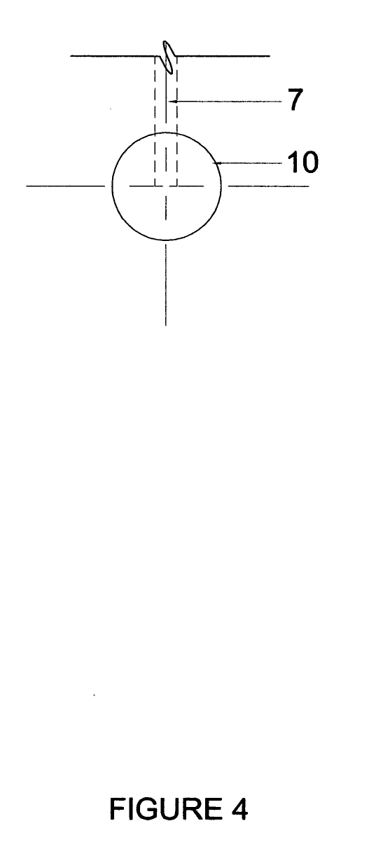

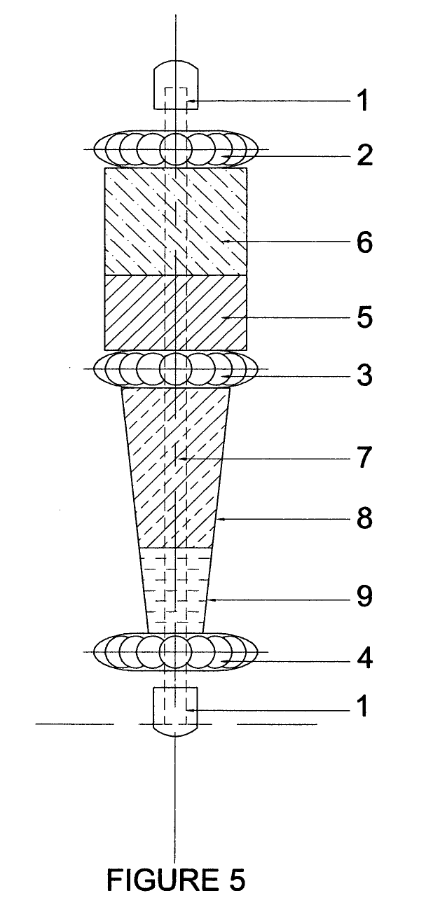

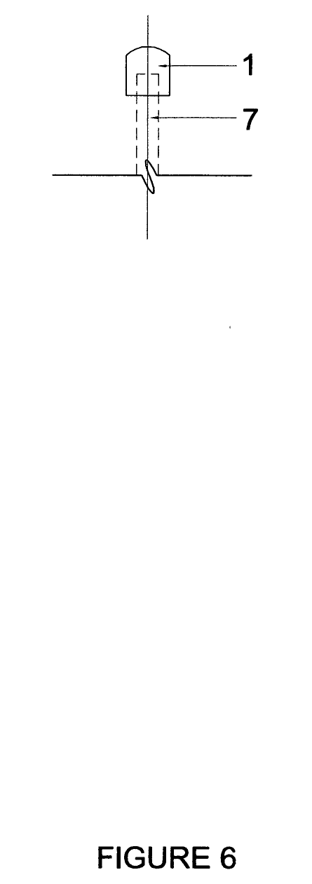

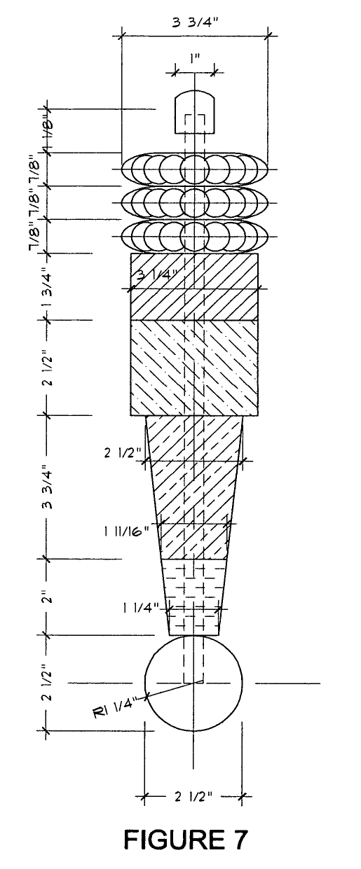

The present invention combines several sources of massage and pressure relief therapy into one massage tool. With reference to FIG. 1, the components of the invention include; two different sized neoprene foam pads 5, 6, three ribbed polyurethane massage wheels 2, 3, 4, one solid rubber ball housing an internal threaded cap 10, a threaded polyurethane removable cap 1, two neoprene handle sleeves 8, 9 and a polyurethane center rod 7 which all of the components slide onto. This multiple use massager encompasses; (1) percussion, effleurage and sports massage FIG. 1, (2) pressure point therapy FIG. 4, 5, 7 (3) spinal mobilization and alignment FIGS. 2, 3 and (4) spinal decompression and relaxation FIG. 5.

### Percussion, Effleurage and Sports Massage

The wheels 2, 3, 4 and rubber ball 10 of the massager as in FIG. 1 can be used as percussive massage tools by tapping or hitting the massager against the user's body. The intensity of the percussive massage can be increased or decreased by the placement of the wheels 2, 3, 4 and order of the foam pads 5, 6 on the device. When the wheels are placed together at the end of the device as in FIG. 1, this increases the weight distribution of this end of the massager and increases the force of the percussive massage. Interchanging the order of the foam pads 5, 6 also gives the user a diversity of percussive massager intensity using the wheels 2, 3, 4. The ability to interchange the number of wheels 2, 3, 4 together on the invention also allows the user to increase or decrease the surface area of the massager making contact with the user. This gives the user a broader or finer contact point for larger or smaller areas of the body. The device can then be used in a variety of forms of effleurage and sports massage by an individual user or on another person.

### Pressure Point Therapy

The two separate ends of the device are used as pressure point release tools as in FIG. 5. One end of the device ends with an 1 ½″ long pressure point knob 1 which can be pressed into the body and held for effective pressure point therapy release. The opposite end of the device, as in FIG. 1, contains a solid rubber ball 10 which embodies a threaded ½″ cap that sits inside the rubber ball 10 and can be removed from the device as in FIG. 4. The rubber ball 10 can be used similarly as the pressure point knob 1 for sustained pressure point release. The rubber ball 10 can also be used as multidirectional pressure point therapy tool when removed from the device and placed between the user and a hard surface. Another feature of the pressure point therapy component of the invention is the use of one of the wheels 2, as a safeguard in case a pressure point held by the user slips suddenly off the point as in FIG. 5. A wheel 2 can be positioned at the end of the device, as in FIG. 5, closest to the pressure point knob 1 and block any further movement of the device in case it would slip away from the user. This safety design of the device allows the user to press with greater force without risking slippage and or preventing increased acceleration of the device into another area of the body and therefore avoiding injury. Another wheel 4 can also be placed at the opposite end of the device as the pressure point knob 1, and is an effective tool for the user or therapist to maintain pressure on the desired pressure point held by the pressure point knob 1. This wheel 4 can be set on the device and used against a variety of surfaces to provide a steady, constant pressure point release while making the effort minimal on the user or therapist holding the point. The user or therapist can hold a pressure point for longer durations of time by the increased surface area of the wheel and the different ways pressure can be maintained against it.

### Spinal Mobilization and Alignment

The invention is also a tool to mobilize the vertebrae of the spine by interchanging the foam pads 5, 6 between the wheels 2, 3 and placing the device between the spine and a hard surface as in FIG. 2, 3. Common pain sources of the spine include misaligned vertebral segments, which when pressed on with enough force, can become aligned and reduce pain. Included in the device are two different sized foam pads 5, 6 which are suitable for larger or smaller users. A larger user will put the larger foam pad 6 between the wheels where the foam pad 6 sits over the spinous processes of the spine. The wheels 2, 3 bilaterally contact the transverse processes of the spine which is used to mobilize the spine. The wheels 2, 3 can also be used unilaterally on the transverse processes of the spine if spinal rotation is present to one side more than the other. This technique effectively aligns and neutralizes the spine which results in decreased muscle tension, muscle spasm, musculoskeletal referred pain, neurological symptoms and headaches. This gives the user a personal tool to deal with issues relating to the spine. Therapists can also use the invention as a spinal mobilizer on their patients and clients. The width of the wheels 2, 3, 4 gives the user an accurate source of spinal mobilization contact area as they are the same width as the average length of a persons' transverse process of the spine. This gives the user a solid contact point that does not require the therapists' hands to perform the manual therapy and in turn reduces the strain on the therapist.

### Spinal Decompression and Relaxation

The final musculoskeletal relief feature of the invention is the use of the device as a tool for spinal decompression and relaxation as in FIG. 5. The foam pads 5, 6 are placed together between the wheels 2, 3 on the device and the user lays their neck over the foam pad 5, 6 bridge and onto a pillow or surface of their choice. The foam pad 5, 6 bridge presses against the part of the neck desired by the user. Common cervical dysfunction in the majority of people exists at the junction of the cervical and thoracic spine. This area becomes hyper-flexed (kyphosis) in most Americans from years of poor posture and sitting. The foam pad 5,6 bridge of the device presses in the opposite direction as the kyphosis of the cervicothoracic (CT) junction which decompresses this area and results in reduction of pain, neurological symptoms, muscle spasms and headaches.

The other benefits of the invention besides the musculoskeletal relief tools include; personal and therapist use of the invention, it may be used anywhere and it is easy to take apart and put back together. The invention is a safe, non-mechanical therapeutic tool for a therapist to use on patients and clients. The device also can be adjusted to the intensity desired by the therapist and used on the client or patient in a variety of ways to achieve musculoskeletal relief. Another way the invention may be used is for aerobic and anaerobic exercise. The device can be used with the wheels all together on one end of the invention and swung any direction to achieve an effective core workout as in FIG. 1. This type of motion is also advantageous for people warming up to play such sports as; baseball, golf and tennis. The device can also be hit against a boxer's abdominal area during training to promote easier, more effective training techniques. The versatility of the device also extends to it being able to be used anywhere and it is easy to take apart and put back together. The device has two threaded inter connecting end pieces 1, 10, which are easily tightened or loosened to each end of the center rod 7 of the device.

### Making the Device

With reference to FIG. 1, the device is made by connecting several components to a center, 11″ long and ¾″ wide cylindrical, hollow polyurethane rod 7. The other components either slide onto the ½″ wide center rod 7 of the device or attach to the two threaded ends of the massager 1, 10. The other components of the device include; an 1 ½″ long and threaded pressure point knob 1, three polyurethane coated, 3 ¾″ ribbed wheels 2, 3, 4, a 1 ¾″ long and 3″ wide neoprene cylindrical foam pad 5, a 2 ½″ long and 3″ wide neoprene cylindrical foam pad 6, a 1 ¼″ and 4 ½″ long neoprene foam sleeve 8,9 which is ¼″ thick and a solid 2 ½″ circumference rubber ball 10 with a ¾″ wide, and 1″ deep hole which fits a threaded plastic connector piece. Each of the components are made separately and then interconnected together to form the invention.

### Using the Device

The massager is used according to the type of therapeutic relief desired by the user. The uses for the massager include; percussive/effleurage/sports massage, pressure point therapy, spinal mobilization and spinal decompression. The massager is tapped or hit against the body with various parts and combinations of parts of the device to perform percussion massage as in FIG. 1, 2, 3. The intensity of the percussive massage depends on the how much force and how many wheels 2, 3, 3 the user puts into the contact from the device into the body. Effleurage can be performed with the massage by rolling the wheels 2, 3, 4 of the device in any combination on the part of the body desired. Sports massage can also be achieved with the invention by using different speeds, directions, techniques and forces with the different components of the device.

Pressure point therapy can be performed by either end of the device being pressed into the body. The pressure point knob 1, rubber ball 10 and wheels 2, 3, 4, as in FIG. 1, 4, 5, 6, can be used as the components to do pressure point therapy anywhere on the body. The pressure point knob 1 is used in areas that require a smaller surface area for pressure. The user can position themselves and the device in multiple ways to perform a variety of forms pressure point release. The rubber ball 10 can also be detached from the device and used against a hard surface to give the user a multidirectional tool for pressure point therapy as in FIG. 4. The wheels 2, 3, 4 can also be positioned in different ways to provide safety and make the device easier to use as in FIG. 5. When one wheel 2, is placed on the same end of the device as the pressure point knob it acts as a safeguard incase the pressure point knob 1 slips off the contact point. The wheel 2 would block any further acceleration of the device if it loses its contact point, preventing any painful contact if the device should slip off the user. The wheel 4 can also be placed at the opposite end of the side being used to perform pressure point therapy. This gives the user or therapist a greater surface area to contact the part of the body they use to perform the pressure point therapy. The wheel 4 reduces strain on the user or therapist by giving them more selection to the point of contact that they make with the device to enable the pressure point therapy.

The invention can be used to mobilize the spine by placing either of the foam pads 5, 6 in between the wheels 2, 3 of the device and the user pushing their body against the device and a hard surface as in FIG. 2, 3. The two different sized pieces of foam 5, 6 are placed individually between the wheels 2, 3 to be used for larger or smaller people. A larger person would select the longer foam pad 6 to put between the wheels as in FIG. 2. The foam pad 6 spaces out the distance of the wheels to make contact with the spinous processes of the spine. This places the wheels 2, 3 of the device over the transverse processes of the spine which gives the user ability to make bilateral simultaneous contact of both transverse processes of the same vertebra. The invention is rolled up and down the spine against a hard surface and the contact point of the wheels 2, 3 mobilizes the spine. The wheel 4 on the opposite end of the device, allows the direction that the device is rolled to be maintained easily by the user without veering to the right or left. This feature enables the user to move the device up and down the body in a straight line, allowing the consistency of the linear path of the device performing spinal mobilization. The wheels 2, 3, 4 can also be used individually or placed together without the foam pads 5, 6 to be used on one side of the spine to mobilize the spine unilaterally.

The two foam pads 5, 6 can be placed together between the wheels on the device to be used for spinal decompression of the neck and upper thoracic area of the spine as in FIG. 5. The user lies face up and places the bottom of the cervical spine and top of the thoracic spine onto the foam pads 5, 6. The user then takes a small pillow or soft object and places it under the base of the head. The foam pad 5, 6 bridge relieves pressure on this area of the spine by the weight of the user forcing the bridge to push against the spine. This helps to align the spine and neutralize pain, muscular tension and neurological discomfort. People whom have chronic neck pain or recovering from a neck injury can use the combined foam pad bridge for effective reduction of their symptoms.

### Improvements of the Device

The invention is distinguishable from other massagers and is improved by several of the features and uses of the device. The ability of the invention to have an adjustable intensity and surface area of contact for percussion, effleurage, sports massage, pressure point therapy and spinal mobilization makes it unique. The user can modify the components of the device to be more user friendly for each individual. Multiple sources of pressure point therapy on the device give the invention the capability to get almost any point on the body. Pressure point therapy is also safer and easier for therapists to perform with this invention from the specific placement of the wheels 2, 3, 4 on the device as in FIG. 5. The wheels 2, 3, 4 can also serve as a bilateral or unilateral pressure point therapy and spinal mobilization tool, as in FIG. 2, 3, 5 giving the user as much pressure and specificity as they desire. Another unique feature of the invention is the use of the rubber ball 10 away from the center rod, as in FIG. 4, which enables the user to have a multidirectional pressure point release device. The foam bridge 5, 6 of the invention, formed by the two foam pads 5, 6 being placed between the wheels 2, 3 provides the user with a unique cervical decompression tool to be used with many types of neck pain sufferers as in FIG. 5. All of these features contribute to the invention and make it effectively useable anywhere for an individual user or a healthcare professional.

What is claimed is:

1. An interchangeable pressure therapy tool for massage, pressure point therapy, spinal mobilization and spinal decompression comprising: a center, cylindrical, hollow polyurethane rod, wherein said rod houses the other components by either sliding onto or attaching to the ends of the said rod; a threaded extension plastic extension knob; three polyurethane coated, ribbed wheels, wherein said wheels are ribbed for massage and able to roll; two neoprene foam cylinders, wherein said foam cylinders are different sized for larger and smaller people; a neoprene foam handle; and a solid rubber ball which fits a threaded plastic connector piece, wherein said rubber ball is removable from the said interchangeable pressure therapy tool for multidirectional pressure point therapy.

2. The interchangeable pressure therapy tool of claim 1, wherein said components are made individually and then interconnected together to form the invention.

3. The interchangeable pressure therapy tool of claim 1, wherein said interchangeable pressure therapy tool to have an adjustable intensity and surface area of contact for the various forms of pressure therapy.

4. The interchangeable pressure therapy tool of claim 1, wherein said wheels are centrally ribbed to centralize the force of weight through the wheel.

5. The interchangeable pressure therapy tool of claim 1, wherein said solid rubber ball is detachable from the device and able to be used away from the invention.

6. The interchangeable pressure therapy tool of claim 1, wherein said foam cylindrical pads are 1 ¾″ and 2 ½″ wide.

7. The interchangeable pressure therapy tool of claim 4, wherein said wheels are 1″ wide.

8. The interchangeable pressure therapy tool of claim 1, wherein said center rod is ¾″ wide.

9. The interchangeable pressure therapy tool of claim 1, wherein said foam bridge is 4 ¼″ wide.

10. The interchangeable pressure therapy tool of claim 4, wherein said wheel can be placed at the end of the device closest to the pressure point knob to provide safety of use during pressure point therapy.

11. The interchangeable pressure therapy tool of claim 4, wherein said wheel can be placed at the opposite end of the device as the pressure point knob to promote feasibility of use by an increased surface area of contact for the user.
